(19) United States
(12) Patent Application Publication
(10) Pub. No.: US 2006/0201806 A1
(43) Pub. Date: Sep. 14, 2006

(54) Method of forming thin film layer on external surface of sensor and sensor manufactured therewith

(75) Inventors: Masanori Iwase, Shiga (JP); Kiyoshi Matsushita, Osaka (JP); Hideki Watanabe, Osaka (JP); Yukio Terauchi, Kyoto (JP); Hiroaki Kosaka, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: HERAEUS ELECTRO-NITE JAPAN, LTD., Takatsuki-shi (JP); MIYAGAWA KASEI INDUSTRY CO., LTD., Osaka-shi (JP)

(21) Appl. No.: 10/544,846

(22) PCT Filed: Feb. 27, 2004
(86) PCT No.: PCT/JP04/02364

§ 371 Date: May 19, 2006

(30) Foreign Application Priority Data
Feb. 28, 2003 (JP) 2003-052275

(51) Int. Cl. G01N 27/26; B05D 5/12; B05D 5/00

(52) U.S. Cl. 204/421; 427/115; 427/258; 427/428.01

(57) ABSTRACT

It is an object of the present invention to provide a method for forming a thin-film layer on the outer surface of a sensor, by which a thin-film layer formed on the surface of a sensor used for measuring the concentration of elements contained in the measurement object such as a molten metal, slag, or gas, can be easily provided with a complex pattern shape of small thickness and a uniformly arranged pattern shape. The method is provided for forming a thin-film layer of a sensor composed of a solid electrolyte which is a molded body having an inner space, a reference substance filled in the inner space, a reference electrode connected to the reference substance and led out to the outside of the inner space, and a thin-film layer comprising a ceramic powder or a metal powder as the main component and formed on the outer surface of the solid electrolyte in such a manner that part of the outer surface is exposed. This thin-film layer is formed by printing.

### BACKGROUND OF THE INVENTION

1. Field of the Invention

The present invention relates to a method for forming a thin-film layer on the outer surface of a sensor and to a sensor fabricated using such a method.

2. Description of the Related Art

In order of increase the degree of refining obtained by adjusting the concentration of melt components to a control standard values and to increase the refining rate in metal refining plants which are typical for steelmaking industry, it is very important to measure rapidly the concentration of elements that require concentration control during refinement, such as oxygen, silicon, and phosphorus that are contained in the molten metal. Accordingly, methods have been developed for measuring the concentration of those elements by using electrochemical sensors. A basic measurement method that can be used when the measurement object has electron conductivity, as a molten metal, is illustrated by FIG. 7. In FIG. 7, the reference numeral 51 stands for a sensor, 51c—a reference electrode, 51d—a reference electrode lead wire, 52—a measurement electrode, 52a—a measurement electrode lead wire, 53—a measurement device, 54—a measurement object such as a molten metal, and 55—a refractory container such as a ladle which accommodates the measurement object 54. With this measurement method the concentration of elements is measured by measuring the electromotive force generated by the electrode reaction at the interface of the sensor 51 using a solid electrolyte, according to the concentration of the element with the measurement device 53 inserted between the measurement electrode 52 and the reference electrode 51c. This measurement method is based on a concentration cell principle, and a substance having ion conductivity of the element which is to be measured is used as the solid electrolyte. For example, when the concentration of oxygen in a molten steel is to be measured, a solid electrolyte from zirconia partially stabilized with magnesia, which is an oxygen ion conductor, is typically used as the solid electrolyte. As shown in FIG. 8A, the sensor 51 used in this measurement method is basically composed of the solid electrolyte 51a which is the aforesaid solid electrolyte from zirconia partially stabilized with magnesia, a reference substance 51b which is mixed power of chromium and chromium oxide with known partial pressure of oxygen, the reference electrode 51c using a molybdenum wire, and the reference electrode lead wire 51d. Furthermore, iron or molybdenum is used for the measurement electrode 52. A large number of probes in which the sensor 51 with the above-described configuration is assembled and integrated with the measurement electrode 52, and a thermocouple are used in the steelmaking departments of metallurgical plants.

The sensor 51 shown in FIG. 8B in which a thin-film layer 51e is formed on the surface of the solid electrolyte 51a of the sensor 51 shown in FIG. 8A is used with respect to certain elements contained in the molten metal. This sensor is also used when the measurement object has electron conductivity, as a molten metal does, and is employed in combination with the measurement electrode 52. Similarly to the above-described method, the concentration measurements are carried out by measuring the electromotive force between the measurement electrode 52 and the reference electrode 51c with the measurement device 53. The thin-film layer formed on the surface of the solid electrolyte 51a in the sensor is generally called an auxiliary electrode. Such sensors are mainly used in the following cases.

Concentration measurements of the elements contained in a molten metal, which is the measurement object, are based on using a sensor employing a concentration cell principle as the electrochemical sensor, as described hereinabove. As a rule, an electrolyte having ion conductivity of the element which is to be measured is required as a solid electrolyte for the aforesaid measurements. However, there is also a measurement method which does not use an electrolyte having ion conductivity of the element which is to be measured, when this element is metal. With this method, as described in Unexamined Japanese Patent Application Laid-open No. S61-260155, the activity value of the element is found and the concentration thereof is measured by using a zirconia solid electrolyte employed in the oxygen sensor as the solid electrolyte, measuring the oxygen potential, that is, the partial pressure of oxygen in the molten metal by bringing the activity value of the oxide to a constant value in the vicinity of zirconia solid electrolyte-molten metal interface with the aforesaid auxiliary electrode, from the oxidation reaction of the element in the molten metal.

Measurement of the concentration of elements such as Cr, Mn, Si, Al, and P contained in the molten metal, which is the measurement object 54, as described, for example, in Unexamined Japanese Patent Application Laid-open No. H5-60726, is an example of using the sensor 51 shown in FIG. 8B based on this method. In this case, the zirconia solid electrolyte comprising ZrO₂ as the main component is used as the solid electrolyte 51a, a mixture of Cr and Cr₂O₃ or Mo and MoO₂ is used as the reference substance 51b, and an auxiliary electrode which is a mixed oxide based on an inorganic oxide comprising the oxide of the aforesaid element which is to be measured is provided as the aforesaid thin-film layer 51e on the surface of the solid electrolyte 51a. In such a sensor, the concentration measurement of the element are carried out by measuring the partial pressure of oxygen which is in equilibrium at the three-phase interface formed by the molten metal, which is the measurement object, the auxiliary electrode, and the solid electrolyte. In such sensors, the formation of this three-phase interface is important, and in order to form the three-phase interface, the auxiliary electrode which is the above-described mixed oxide, that is, the thin-film layer, has to be formed on the surface of the solid electrolyte in such a manner that part of this surface is exposed.

When the measurement object is gas of slag of molten oxides that have no electron conductivity, the sensor 51 shown in FIG. 8C is used in which a thin-film layer lead wire 51f is connected to the thin-film layer 51e of the sensor 51 shown in FIG. 8B. When actual concentration measurements are conducted with this sensor, the thin-film layer 51e with the thin-film layer lead wire 51f connected thereto is used without using the measurement electrode 52. The thin-film layer 51e serving as the measurement electrode is typically formed using platinum and the measurements are carried out based on the measurement principle such that oxygen concentration is measured by inducing an electrode reaction by supplying free electrons from a platinum thin-film layer in the three-phase interface of the measurement object in the form of a molten slag or gas, the zirconia solid electrolyte, and the platinum thin-film layer and by generating an electromotive force between the reference electrode 51c and the thin-film layer lead wire 51f. Therefore, in this case, too, as in the above-described case, in order to form the three-phase interface, the thin-film layer serving as the measurement electrode has to be formed on the surface of the solid electrolyte in such a manner that part of this surface is exposed.

The above-described thin-film layer serving as an auxiliary electrode or a measurement electrode formed on the surface of a solid electrolyte has been conventionally formed by a method comprising the steps of mixing the above-described mixed oxide or the like or a platinum powder or the like with an organic solvent or the like to obtain a paste and applying this paste in the dot-like or spiral-like fashion to the surface of the solid electrolyte, for example in the same manner as described in Unexamined Japanese Patent Application Laid-open No. S61-260155.

However, from the standpoint of increasing the concentration measurement speed, it is preferred that the aforesaid three-phase interface be enlarged. For this purpose, is it described that patterns be formed which incorporate the pattern shape of the thin-film layer in a complex fashion when the thin-film layer, which is a mixed oxide or the like, is formed on the surface of the solid electrolyte in such a manner that part of the surface is exposed. However, it is not easy to coat the paste-like oxide or the like so as to obtain such a complex pattern. Furthermore, it is desirable that the aforesaid patterns be arranged as uniformly as possible to increase the efficiency of concentration measurements. Such an arrangement is, however, not easy to realize with a coating process. Moreover, when a method for coating a paste-like mixed oxide prepared by mixing with an organic solvent was used to form the aforesaid thin-film layer, the thin-film layer always had a large thickness. As a result, when the sensor fabricated in such a manner was used for measurements, because a molten metal had a rather high temperature, the organic solvent was evaporated and the thin-film layer sometimes peeled off and fell down under the weight of the coated mixed oxide.

### SUMMARY OF THE INVENTION

The present invention was created to resolve the above-described problems and it is an object of the present invention to provide a method for forming a thin-film layer on the outer surface of a sensor, by which a thin-film layer formed on the surface of a sensor used for measuring the concentration of elements contained in the measurement object such as a molten metal, slag, or gas, can be easily provided with a complex pattern shape of small thickness and a uniformly arranged pattern shape.

The method for forming a thin-film layer of a sensor in accordance with the present invention is a method for forming a thin-film layer of a sensor composed of a solid electrolyte which is a molded body having an inner space, a reference substance filled in the inner space, a reference electrode connected to the reference substance and led out to the outside of the inner space, and a thin-film layer comprising a ceramic powder or a metal powder as the main component and formed on the outer surface of the solid electrolyte in such a manner that part of the outer surface is exposed, wherein the thin-film layer is formed by printing. The molded body as referred to herein means that it is in the form of a solid body. No specific limitation is placed on the method for fabrication thereof, and it can be molded by a method other than that using a mold such as a metal mold for molding.

In the above-described method for forming a thin-film layer of a sensor, the pattern shape of the surface of the thin-film layer may be an assembly of independent patterns or a continuous shape.

By applying the above-described method for forming a thin-film layer of a sensor to a sensor in which a thin-film layer lead wire is connected to the thin-film layer it is possible to create a sensor for measurement objects that have no electron conductivity, such as slags and gases.

In the above-described method for forming a thin-film layer of a sensor, screen printing or pad printing may be used for the printing.

In the above-described method for forming a thin-film layer of a sensor, the recommended thickness of the thin-film layer is 500 μm or less.

In the above-described method for forming a thin-film layer of a sensor, the molded body of the solid electrolyte may be in the form of a cylindrical Tammann tube which is closed at one end thereof.

The sensor in accordance with the present invention is composed of a solid electrolyte which is a molded body having an inner space, a reference substance filled in the inner space, a reference electrode connected to the reference substance and led out to the outside of the inner space, and a thin-film layer comprising a ceramic powder or a metal powder as the main component and formed on the outer surface of the solid electrolyte in such a manner that part of the outer surface is exposed, wherein the thin-film layer is formed by printing.

In the aforesaid sensor, the pattern shape of the surface of the thin-film layer may be an assembly of independent patterns or a continuous shape.

By applying the above-described configuration to a sensor in which a thin-film layer lead wire is connected to the thin-film layer it is possible to create a sensor for measurement objects that have no electron conductivity, such as slags and gases.

In the aforesaid sensor, screen printing or pad printing may be used for the printing.

In the aforesaid sensor, the thickness of the thin-film layer may be 500 μm or less.

In the aforesaid sensor, the molded body of the solid electrolyte may be in the form of a cylindrical Tammann tube which is closed at one end thereof.

### BRIEF DESCRIPTION OF THE DRAWINGS

FIG. 1A is a cross-sectional view, FIG. 1B is a plan view, and FIG. 1C is a rear view of the sensor which is an object of the embodiment;

FIGS. 2A to 2E illustrate a method for forming a thin-film layer using screen printing of the embodiment;

FIG. 3 is a cross-sectional view of a submersible lance using a sensor having a thin-film layer formed thereon in the embodiment;

FIGS. 4A to 4E illustrate examples of pattern shapes (other than those of the embodiment) of the thin-film layer formed on the outer surface of the Tammann tube;

FIGS. 5A to 5F illustrate a method for forming a thin-film layer using pad printing of another embodiment;

FIG. 6 is a cross-sectional view of a sensor in which the thin-film layer is formed as a measurement electrode;

FIG. 7 illustrates a method for measuring the concentration of an impurity element in a molten metal of the conventional example; and

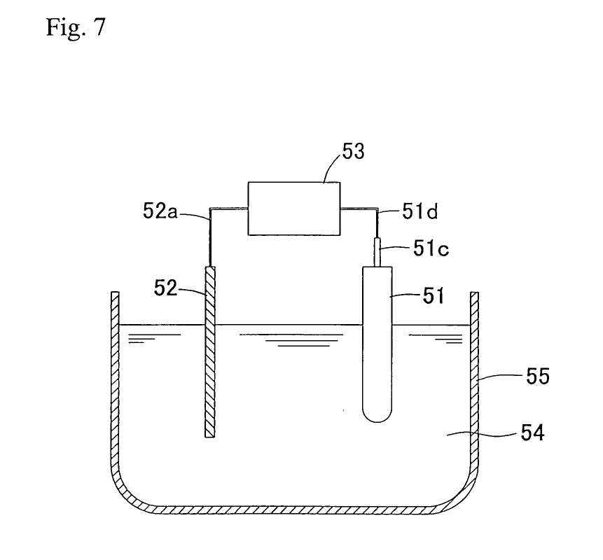

FIGS. 8A to 8C are cross-sectional views of a sensor used for concentration measurements of the conventional example.

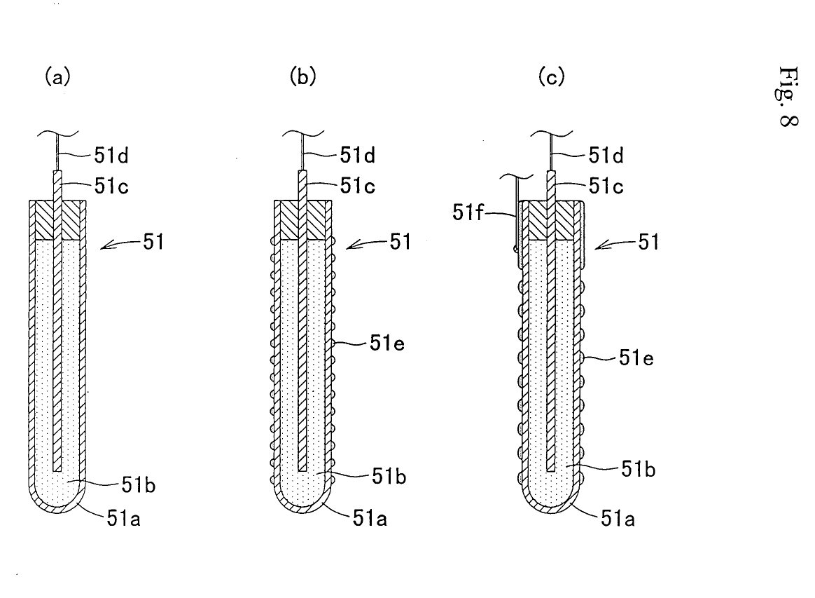

### DESCRIPTION OF THE PREFERRED EMBODIMENTS

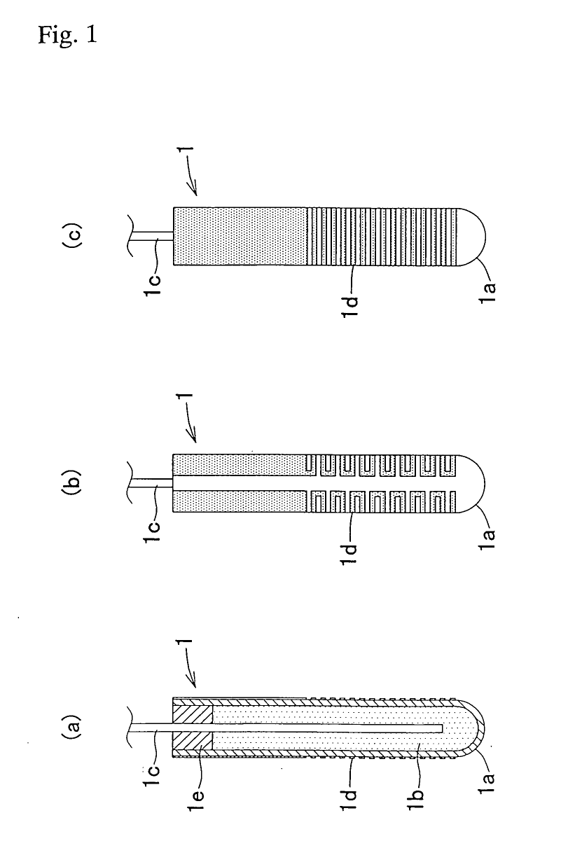

The present invention will be described below in greater detail based on the embodiments thereof illustrated by the appended drawings. The present invention relates to a method for forming a thin-film layer which is to be formed on the surface of a sensor used for measuring the concentration of elements contained in a measurement object such as a molten metal, a slag which is the oxide melt, or a gas. The present invention also relates to a sensor formed by using this formation method. In the present embodiments, explanation will be conducted with respect to a sensor in which a thin-film layer was formed as the aforesaid auxiliary electrode. FIG. 1 illustrates an example of such a sensor 1. FIG. 1A is a cross-sectional view, FIG. 1B is a front view, and FIG. 1C is a rear view thereof. This sensor 1 is used when the object of measurement is a molten metal having electron conductivity. In actual measurements, the sensor is combined with a measurement electrode, as was described hereinabove.

Referring to FIGS. 1A, 1B, and 1C, the sensor 1 has a test tube shape in which the upper und is open and the lower end is closed, this tube being the so-called Tammann tube. The Tammann tube is a molded body which is molded from a solid electrolyte 1a having an inner space. The molded body as referred to herein means that it is in the form of a solid body. No specific limitation is placed on the method for fabrication thereof, and it can be molded by a method other than that using a mold such as a metal mold for molding. The inner space of the solid electrolyte 1a is filled with a reference substance 1b. A reference electrode 1c is connected to the reference substance 1b and led out through the open portion at the upper end of the Tammann tube. A sealing portion 1e for sealing the inner space of the solid electrolyte 1a is provided in the open portion at the upper end of the tube in order to seal the reference substance 1b in the inner space of the solid electrolyte 1a. A thin-film layer 1d is formed on the outer surface of the solid electrolyte 1a.

The aforesaid sensor is based on the principle of an oxygen concentration cell. As described hereinabove, a zirconia solid electrolyte comprising ZrO₂ as the main component, such as a zirconia solid electrolyte partially stabilized with magnesia, is used as the solid electrolyte 1a, a mixture of Cr and Cr₂O₃ or Mo and MoO₂ with known partial pressure of oxygen is used as the reference substance 1b, Mo is used as the reference electrode 1c, and alumina cement is used as the sealing portion 1e. The substance used for the thin-film layer 1d formed on the outer surface of the solid electrolyte 1a differs depending on the element which is to be measured. For example, when the element to be measured is Cr, Mn, Si, Al, or P, mixed oxides are used which contain as the main component an inorganic compound comprising an oxide of the element. Those mixed oxides can be referred to as ceramic powders. More specifically, when the element to be measured is P, a mixture of Al₂O₃ and AlPO₄ is used. In order to form a three-phase interface of a molten metal, the thin-film layer 1d serving as an auxiliary electrode, and the solid electrolyte when the sensor is used for measurements, the thin-film layer 1d has to be formed in such a manner that part of the outer surface of the zirconia solid electrolyte serving as the solid electrolyte 1a is exposed.

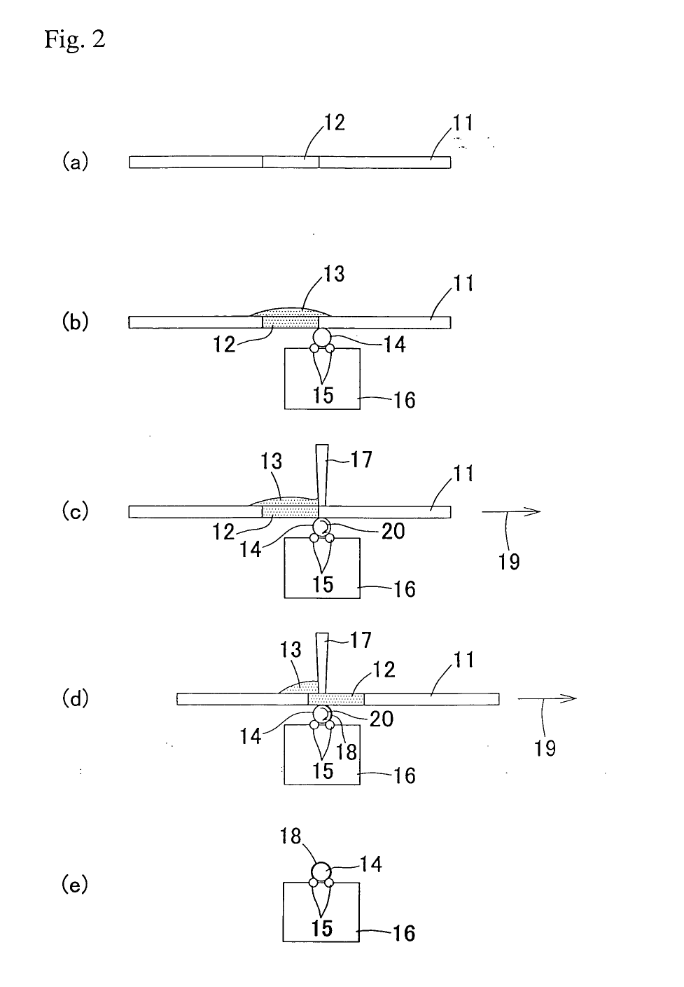

Described hereinbelow is a method for forming the thin-film layer 1d on the outer surface of the Tammann tube which is formed from a zirconia solid electrolyte serving as the solid electrolyte 1a of the above-described sensor. With this method, the thin-film layer 1d is formed by screen printing. FIG. 2 illustrates this method. First, as shown in FIG. 2A, the pattern shape of the thin-film layer 1d which is to be formed on the outer surface of the Tammann tube is formed on a screen printing mask 11. This screen printing mask 11 is made from a meshed silk, polyester or SUS (stainless steel), and a printing pattern is formed on the surface of this screen printing mask 11. The reference numeral 12 in FIG. 2A denotes the printing pattern formation zone of the screen printing mask 11. In the present embodiment, this pattern has a shape shown in FIGS. 1B and 1C and serves as a continuous pattern.

Further, as shown in FIG. 2B, the Tammann tube 14 is placed on a Tammann tube holder 15 provided on a holder support stand 16, and the screen printing mask 11 is placed thereon. During screen printing the Tamman tube holder 15 rotates following the rotation of the Tammann tube. A printing paste 13 used as the printing ink is placed on the printing pattern formation zone 12 of the screen printing mask 11. The printing paste 13 is fabricated by mixing a ceramic powder which is a mixed oxide containing as the main component an inorganic compound comprising an oxide of the element which is to be measured, for example, alumina, zirconia aluminum phosphate, and silica, with a vehicle composed of a binder and a solvent. Resins such as ethyl cellulose resin, nitrocellulose resin, acrylic resin, and butyral resin can be used as the binder, and high-boiling solvents such as butyl carbitol, butyl carbitol acetate and terpineol can be used as the solvent.

Then, as shown in FIGS. 2C, 2D, and 2E, if the screen printing mask 11 is moved in the direction of arrow 19, while the printing paste 13 is being held with a squeegee 17, the Tammann tube 14 will rotate in the direction of arrow 20 and the pattern formed in the printing pattern formation zone 12 of the screen printing mask 11 will be printed with the printing paste 13 on the outer surface of the Tamman test rube 14 and a thin-film layer 18 will be formed. In this screen printing process, the thickness of the printed layer can be controlled to a constant value by automatically controlling the printing process, and the printing thickness can be set freely. As described hereinabove, from the standpoint of peeling, the smaller thickness of the thin-film layer 18 is preferred and a thickness of not more than 500 μm is recommended. However, it is also possible to obtain a thickness of not more than 200 μm, sometimes, 10-20 μm. When the Tammann tube 14 having the thin-film layer 18 formed thereon by such printing on the outer surface is dried for 5-30 minutes at a temperature of 100-200° C., the thin-film layer 18 formed by the printed printing paste 13 dries out and becomes adhesive.

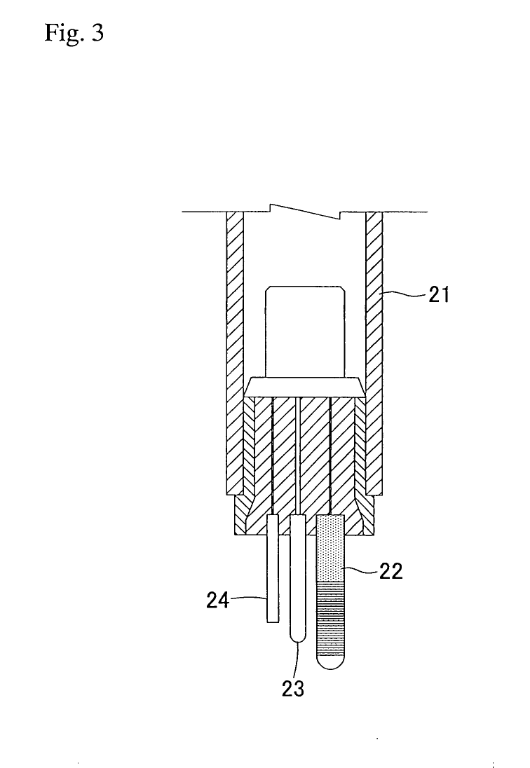

The assembly of the sensor is then completed by inserting and installing the aforesaid reference substance and solid electrolyte inside the Tammann tube 14 that has a thin-film layer formed on the outer surface thereof by screen printing conducted in the above-described manner and forming a sealing portion. The sensor 22 thus assembled is usually used, as shown in FIG. 3, by mounting together with a thermocouple 23 and a measurement electrode 24 on the distal end of a probe 21 in a submersible lance equipment of steelmaking converter of a steelmaking plant and immersing into the steel melt inside the converter.

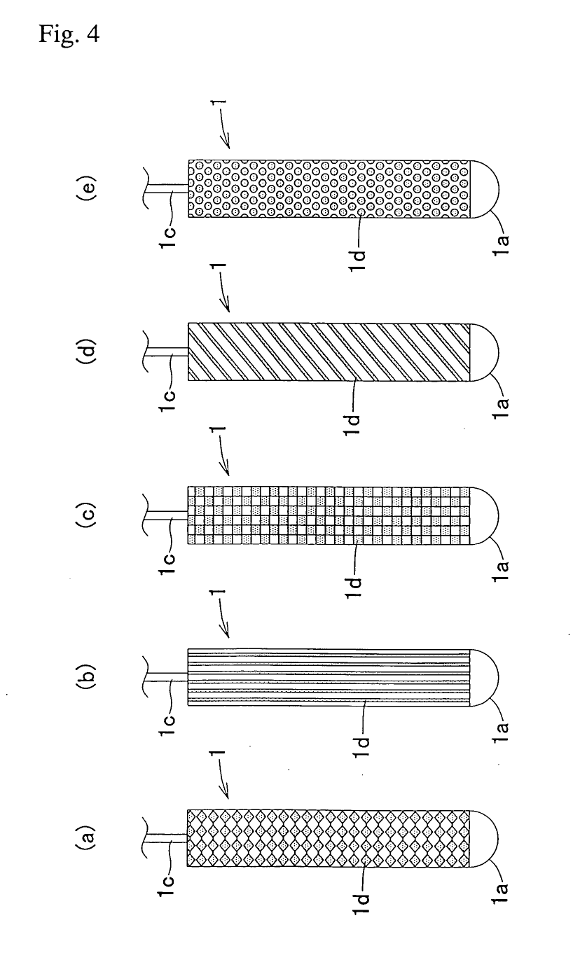

In the above-described embodiment, the pattern of the thin-film layer 18 formed on the outer surface of the Tammann tube 14 was a continuous pattern shown in FIGS. 1B and 1C, but a pattern which is an assembly of independent patterns, such as shown in FIGS. 4A through 4E may be also used.

With the above-described embodiment, a thin-film layer is formed on the outer surface of the Tammann tube 14 by screen printing. Therefore, a pattern of complex shape and small thickness can be easily obtained. Furthermore, a constant product quality can be maintained and the production efficiency can be increased. Furthermore, obtaining a uniform pattern shape in the printing pattern formed on the screen printing mask 11 makes it possible to obtain a pattern shape of the thin-film layer which is uniformly disposed on the outer surface of the Tammann tube and to form a variety of patterns according to the desired object. Furthermore, thin-film layers using a variety of materials corresponding to the elements which are to be measured can be formed by changing the composition of the printing paste.

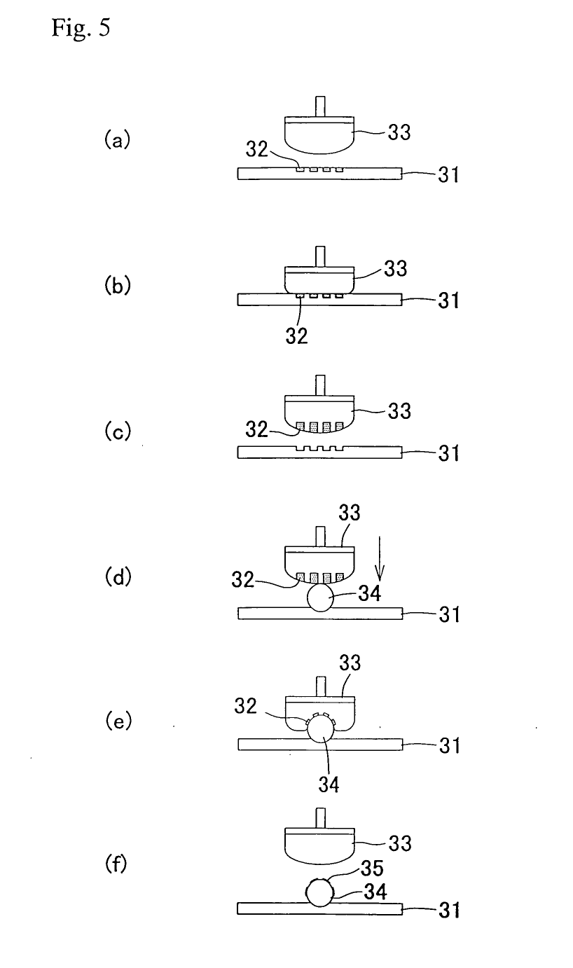

In the above-described embodiment, screen printing was used as the printing method. However, pad printing may be also used. FIG. 5 illustrates a method for forming a thin-film layer by a pad printing process. Pad printing is a kind of engraved printing. As shown in FIGS. 5A through 5C, a printing paste 32 used as a printing ink on an engraved plate 31 is transferred onto a soft pad 33 made from, e.g., a silicone rubber in the form of a hemisphere or a boat bottom and then, as shown in FIGS. 5D through 5F, the pad 33 is pressed against the Tammann tube 34 and the printing paste 32 which is the ink present on the pad 33 is transferred onto the Tammann tube 34 and a thin-film layer 35 is formed. The operation effect of this printing method is identical to that of screen printing.

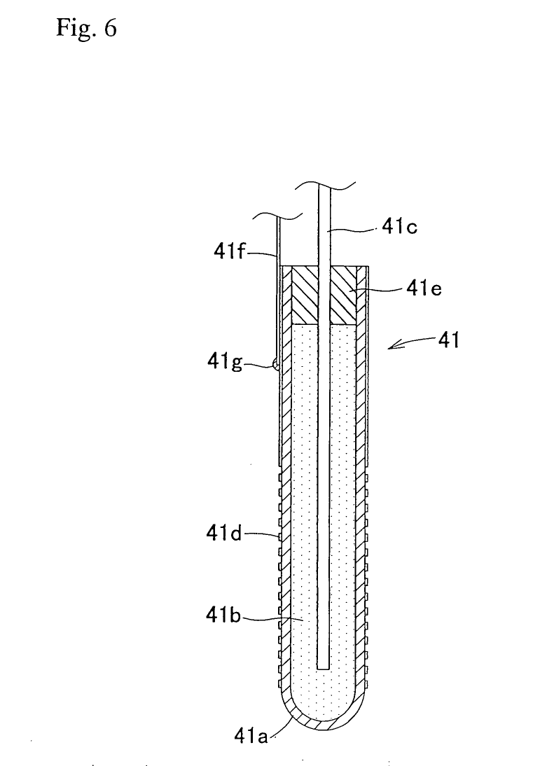

In the above-described embodiment, the explanation was provided with respect to a sensor in which the thin-film layer was formed as an auxiliary electrode. However, the thin-film layer can be also formed in the same manner on the surface of a sensor in which the thin-film layer serves as the above-described measurement electrode, this sensor being used when the object of measurement is a slag or gas having no electric conductivity. FIG. 6 illustrates an example of such a sensor. In the case of a sensor 41 shown in the figure, a thin-film layer 41d is formed by printing, then heating is conducted in a high-temperature sintering furnace to sinter the thin-film layer 41d with the surface of a solid electrolyte 41a, followed by connecting a lead wire 41f of the thin-film layer to the thin-film layer 41d. An adhesive paste comprising metal components is used for such a connection. Because the thin-film layer 41d can be used as the measurement electrode, the thin-film layer 41d has to have electron conductivity and a paste having a metal powder admixed thereto is used for the printing paste employed for printing the thin-film layer 41d. Platinum is a typical metal suitable for this purpose, but gold and silver can be also used. Furthermore, because the thin-film layer 41d of the sensor is used, as described hereinabove, as a measurement electrode, a continuous pattern shape is required, and it is inappropriate to use a pattern representing an assembly of independent patterns that was used as the sensor in which the thin-film layer was used as the above-described auxiliary electrode. In FIG. 6, the reference numeral 41a stands for a solid electrolyte, 41b—reference electrode, 41c—lead wire of reference electrode, 41e—sealed portion, and 41g—lead wire connection of thin-film layer.

With the above-described method for forming a thin-film layer of a sensor in accordance with the present invention, the thin-film layer is formed on the outer surface of a solid electrolyte such as a Tammann tube by printing such as screen printing or pad printing. Therefore, a complex pattern shape of small thickness can be easily obtained, products of constant quality can be obtained, and production efficiency can be increased. Moreover, the pattern of the thin-film layer can be uniformly disposed on the outer surface of a solid electrolyte such as a Tammann tube 14 and a variety of patterns can be formed according to application. Furthermore, changing the composition of the printing paste makes it possible to form a thin-film layer using a variety of materials corresponding to the application of the sensor.

1. A method for forming a thin-film layer of a sensor composed of a solid electrolyte which is a molded body having an inner space, a reference substance filled in said inner space, a reference electrode connected to the reference substance and led out to the outside of the inner space, and a thin-film layer comprising a ceramic powder or a meteal powder as the main component and formed on the outer surface of said solid electrolyte in such a manner that part of the outer surface is exposed, wherein
said thin-film layer is formed by printing.

2. A method for forming a thin-film layer of a sensor, according to claim 1, wherein the pattern shape of the surface of said thin-film layer is an assembly of independent patterns.

3. A method for forming a thin-film layer of a sensor, according to claim 1, wherein the pattern shape of the surface of said thin-film layer is continuous shape.

4. A method for forming a thin-film layer of a sensor, according to claim 3, wherein a thin-film layer lead wire is connected to said thin-film layer.

5. A method for forming a thin-film layer of a sensor, according to claim 1, wherein screen printing is used for said printing.

6. A method for forming a thin-film layer of a sensor, according to claim 1, wherein pad printing is used for said printing.

7. A method for forming a thin-film layer of a sensor, according to claim 1, wherein the thickness of said thin-film layer is 500 μm or less.

8. A method for forming a thin-film layer of a sensor, according to claim 1, wherein said molded body of said solid electrolyte is in the form of a cylindrical Tammann tube which is closed at one end thereof.

9. A sensor composed of a solid electrolyte which is a molded body having an inner space, a reference substance filled in said inner space, a reference electrode connected to the reference substance and led out to the outside of the inner space, and thin-film layer comprising a ceramic powder or a metal powder as the main component and formed on the outer surface of said solid electrolyte in such a manner that part of the outer surface is exposed, wherein said thin-film layer is formed by printing.

10. A sensor according to claim 9, wherein the pattern shape of the surface of said thin-film layer is an assembly of independent patterns.

11. A sensor according to claim 9, wherein the pattern shape of the surface of said thin-film layer is continuous shape.

12. A sensor according to claim 11, wherein a thin-film layer lead wire is connected to said thin-film layer.

13. A sensor according to any claim 2, wherein screen printing is used for said printing.

14. A sensor according to claim 9, wherein pad printing is used for said printing.

15. A sensor according to claim 9, wherein the thickness of said thin-film layer is 500 μm or less.

16. A sensor according to claim 9, wherein said molded body of said solid electrolyte is in the form of a cylindrical Tammann tube which is closed at one end thereof.
